(19) United States
(12) Patent Application Publication
(10) Pub. No.: US 2009/0028084 A1
(43) Pub. Date: Jan. 29, 2009

(54) METHOD FOR REDUCING USER EQUIPMENT POWER CONSUMPTION UNDER A COMMUNICATION NETWORK

(75) Inventor: Shan-Wei Ping, Tao Yuan (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HIGH TECH COMPUTER, CORP., Tao Yuan (TW)

(21) Appl. No.: 11/828,330

(22) Filed: Jul. 25, 2007

(51) Int. Cl. G08C 17/00

(52) U.S. Cl. 370/311

(57) ABSTRACT

A method for reducing UE power consumption under a communication network is disclosed. The key principle of the method is an algorithm to force a RRC connection between a communication network and a UE to be released when mail client completes the synchronization process and the UE has no activity. The method includes steps of: (a) checking if a user inactive event occurs in the UE; (b) sending a signaling connection release message on a dedicated control channel from the UE.

### BACKGROUND OF THE INVENTION

1. Field of Invention

The present invention relates to a method for reducing user equipment (UE) power consumption under a communication network, and in particular to a method for reducing UE power consumption under a Wideband Code Division Multiple Access (WCDMA) network with mail service.

2. Description of Related Art

With any wireless device currently on the market, in order to achieve real time mail service, some kind of synchronization algorithm has to be in place to maintain the link between the UE and the communication network. Most communication networks will tear down the link if link has not been used for certain period of time to have better resource planning purpose. However, almost all mail synchronization process posts a battery consumption defect on wireless device under the communication network.

In the WCDMA network with mail service, the mail client relies on the some kind of synchronization mechanisms (ex: Heartbeat establishment) which are proprietary to mail vendors to maintain the link between the UE and the WCDMA network. However, in order to maintain the link, some packets of the UE will need to send to the mail server through the WCDMA Network. The synchronization packet will be sent through the WCDMA network in the CELL_DCH state or in the CELL_FACH state.

FIG. 1 is a scheme diagram showing the sample of Heartbeat establishment between the UE 101 and the WCDMA network 102. The mail client 100 is an embedded software of the UE 101. The mail server 103 is connected to the WCDMA network 102. At time T=0, the UE 101 checks if any items change in the next X minutes (Step 1S00). At time T=X, the UE 101 receives checking result from the WCDMA network 102, wherein, the checking result presents “OK” meaning that no items changes in the X minutes (Step 1S01). And after receiving the checking result at time T=X, the UE 101 checks if any items change in the next Al minutes (Step 1S02). At time T=Y, the UE 101 receives the checking result from the WCDMA network 102, wherein, the checking result presents “change” meaning that a new item in the inbox of the mail server 103 (Step 1S03). And after receiving the checking result at time T=Y, the UE 101 sends the synchronization packet to synchronize the inbox of the mail server 103 (Step 1S04). The UE 101 also checks if any items change in the next X+Δ1 minutes (Step 1S05). At time T=Y+X+Δ1, the UE 101 receives checking result from the WCDMA network 102, wherein, the checking result presents “OK” (Step 1S06). The UE 101 also checks if any items change in the next Δ2 minutes (Step 1S07). At time T=Y+X+Δ2, the UE 101 receives no response from the WCDMA network 102 (Step 1S08). And the UE 101 also checks if any items change in the next Δ1 minutes (Step 1S09).

In summary, in FIG. 1, the establishment between the UE 101 and the WCDMA network 102 comprises steps of: (a) checking if any items change in the next specified time; (b) responding the checking result; and (c) synchronizing the inbox of the mail server 103.

The WCDMA network may be a 3rd generation (3G) network or a High Speed Data Packet Access (3.5G, HSDPA) network. In a 3G or 3.5G network, data can be transferred or received in the CELL_DCH or CELL_FACH state. Typical transition of the UE under a 3G or 3.5G network is from the IDLE state to the CELL_DCH state, from the CELL_DCH state to the CELL_FACH state, and then back to the CELL_PCH or the IDLE state from the CELL_FACH state. Wherein, being back to the CELL_PCH or the IDLE state from the CELL_FACH state depends on the WCDMA network venders and operators.

Referring to FIG. 2, FIG. 2 is a state diagram showing typical transition of lo the UE under the WCDMA network. When the UE finish transferring or receiving data, the WCDMA network will start an inactivity timer for the CELL_DCH state 200 and the CELL_FACH state 201, when the timeout interval of the inactivity timer is expired, the WCDMA network will commend the UE to move to next state and eventually release the resource accordingly. As showed in FIG. 2, when the DCH timeout interval counted by the inactivity timer is expired, the UE will go to the CELL_FACH state 201 from the CELL_DCH state 200. And then, when the FACH timeout interval counted by the inactivity timer is expired, the UE will go to the CELL_PCH, URA_PCH or IDLE state 202 from the CELL_FACH state 201. The UE in the CELL_PCH, URA_PCH or IDLE state 202 will be commended to release the radio resource by the network.

Investigation has found that average business person receives 100 emails every day. Thus it is important for the WCDMA network to have mail service. If a user wants his mail inbox to keep alive messages, it is essential to maintain the synchronization between the UE and the WCDMA network, and the Heartbeat establishment must be generated as often as once every 5 to 60 mins. So that, data requires the WDCMA network resource to send in the CELL_DCH or CELL_FACH state. Wherein, to send data in the CELL_DCH or CELL_FACH state depends on the implementation of the WCDMA network and the data size.

Referring to FIG. 3, FIG. 3 is a scheme diagram showing power consumption on Radio Resource Control (RRC) transition. After synchronization process being completed by the mail client, the UE has to wait for the WCDMA network to release the RRC connection based on the DCH timeout interval and the FACH timeout interval counted by the inactivity timer, and the inactivity timer is set by the WCDMA network operator. These two timeout interval values can be varied from 10s to 30s between different the WCDMA network operators. In FIG. 3, it can be seen that after the synchronization process being completed, the UE has to wait for the DCH timeout interval 300 and the FACH timeout interval 301 before the WCDMA network sent the RRC connection release message or a physical channel reconfiguration to command the UE to go to the CELL_PCH, URA_PCH or IDLE state (go to IDLE state in this example). For completing synchronization process, the LE will waste significant power during the DCH timeout interval 300 and the FACH timeout interval 301 waiting for the WCDMA network to release the RRC connection. Wherein, the block 302 presents the wasted power during the DCH timeout interval 300, and the block 303 presents the wasted power during the FACH timeout interval 301.

As presented above, the current WCDMA network with mail service on RRC transition will waste much power of the UE. And thus the lifetime of the battery in the UE will decrease because of the wasted power. In order to save this wasted LE power of the communication network on RRC transition and to prolong the lifetime of the battery in the UE, the invention provides a method for reducing UE power under the communication network.

### SUMMARY OF THE INVENTION

The invention provides a method for reducing UE power consumption under a communication network, so as to prolong the lifetime of the battery in the UE.

The invention provides a method for reducing UE power consumption in a CELL_FACH or CELL_DCH state under a WCDMA network with mail service in addition, so as to save the wasted power of the UE in the DCH and FACH timeout interval and prolong the lifetime of the battery in the UE.

The invention provides a method for reducing UE power consumption under a communication network, the method comprises: (a) checking if a user inactive event occurs in the UE; (b) sending a signaling connection release message from the UE.

In embodiments, the signaling connection release may be for Packet Switching (PS) domain to the communication network. The communication network may be a WCDMA network with mail service, even with real time mail service. The user inactive event may be defined by a software program which can be executed in the UE, and user inactive event may include an event of screen off, an event of data guard time expiration or both of these two events.

The invention provides a method for reducing UE power consumption in a CELL_FACH or CELL_DCH state under a WCDMA network with mail service, the method comprises: (1) checking if a user inactive event occurs in the UE; (2) sending a signaling connection release message from the UE if the user inactive event occurs. Wherein, the signaling connection release message is for PS domain to the communication network, and the user inactive event in the UE being defined by a software program which can be executed in the UE.

In embodiments, the user inactive event may be defined by a software program which can be executed in the UE, and user inactive event may include an event of screen off, an event of data guard time expiration or both these two events.

As above, the methods provided by the invention can save the wasted UE power of the communication network on RRC transition and prolong the lifetime of the battery in the UE.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a scheme diagram showing the sample of Heartbeat establishment between the UE 101 and the WCDMA network 102.

FIG. 2 is a state diagram showing typical transition of the UE under the WCDMA network.

FIG. 3 is a scheme diagram showing power consumption on RRC transition.

FIG. 4 is a flow diagram showing an embodiment provided by the invention.

FIG. 5 is the flow diagram showing the RRC connection release using the method provided by the invention.

FIG. 6 is a state diagram showing the transition of the UE under the CDMA network using the method provided by the invention.

FIG. 7 is a scheme diagram showing power consumption on RRC transition of FIG. 6.

FIG. 8 is a state diagram showing the transition of the UE under the WCDMA network using the method provided by the invention.

FIG. 9 is a scheme diagram showing power consumption on RRC transition of FIG. 8.

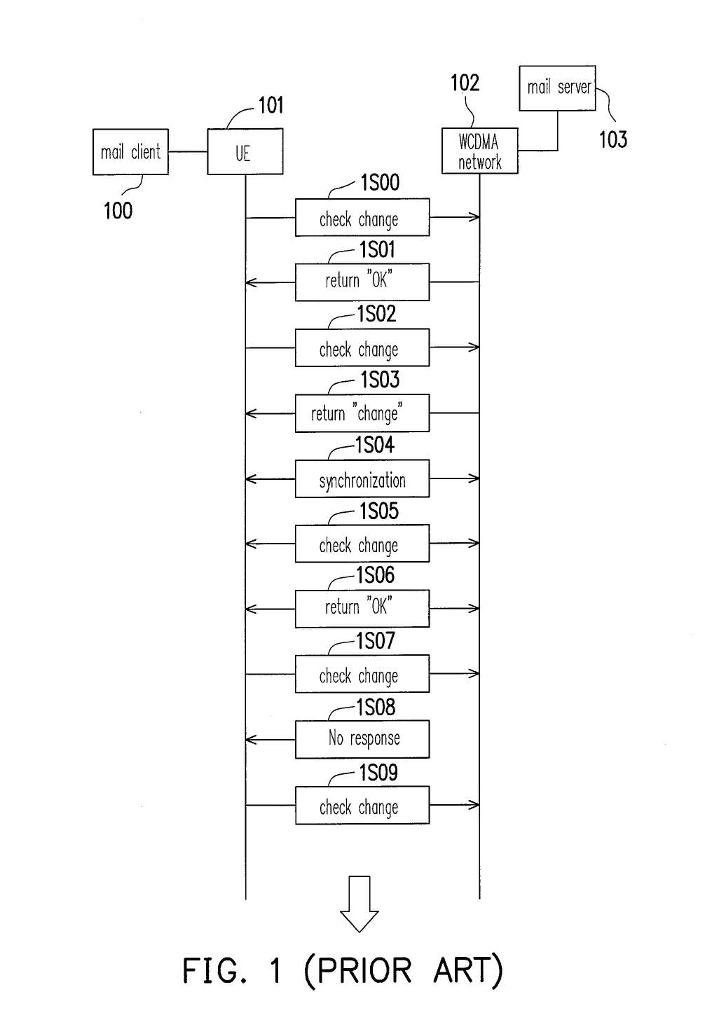

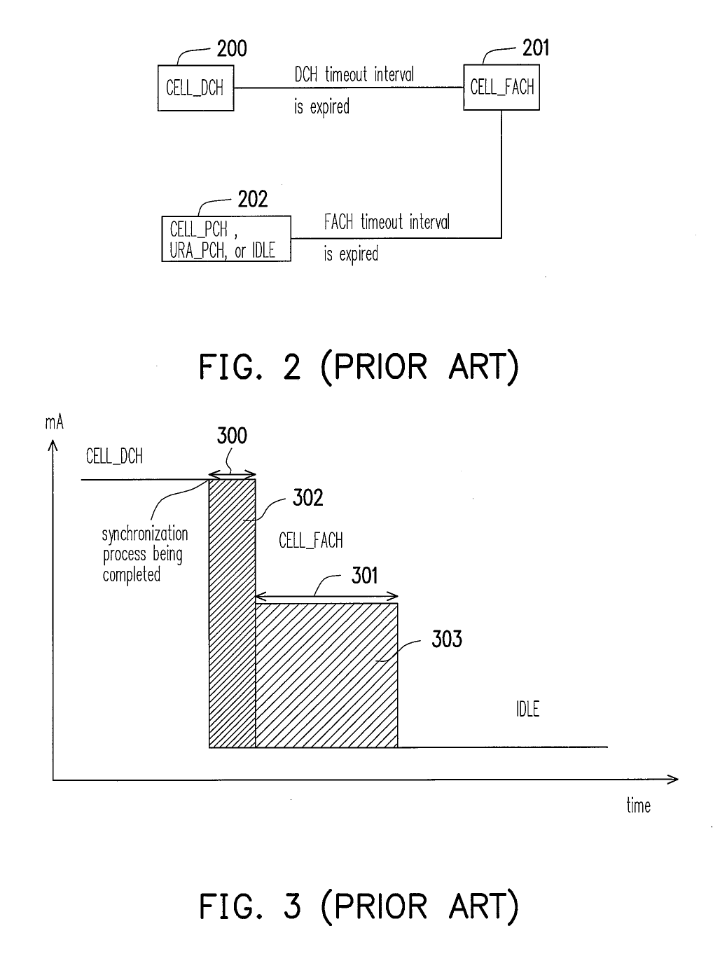

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

The invention provides a method for reducing UE power consumption under the communication network to prolong the lifetime of the battery in the UE. The method provide by the invention will reduce power consumption of the UE significantly when the mail client is enabled in the mail client enabled wireless device under the communication network (ex: WCDMA network).

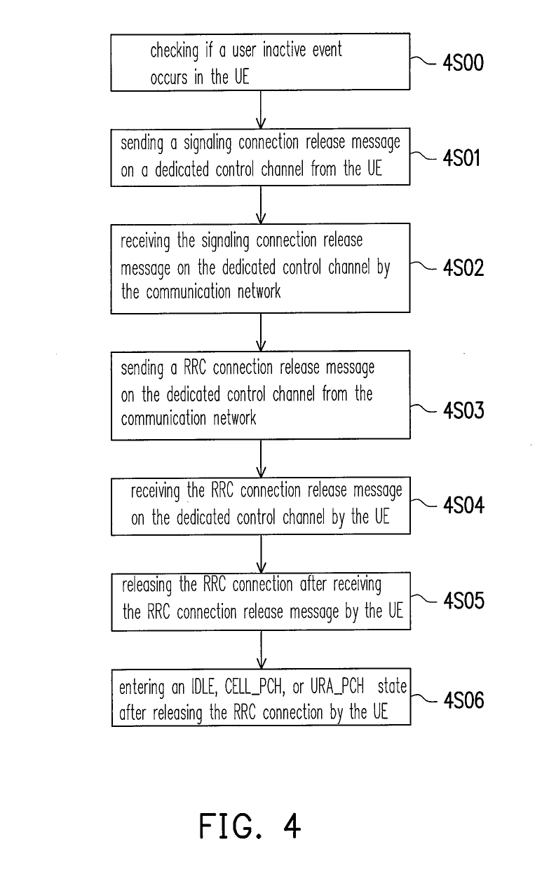

Referring to FIG. 4, FIG. 4 is a flow diagram showing an embodiment provided by the invention. In FIG. 4, the method of the embodiment comprises steps of: checking if a user inactive event occurs in the UE (Step 4S00); sending a signaling connection release message on a dedicated control channel from the UE (Step 4S01); receiving the signaling connection release message on the dedicated control channel by the communication network (Step 4S02); sending a RRC connection release message on the dedicated control channel from the communication network (Step 4S03); receiving the RRC connection release message on the dedicated control channel by the UE (Step 4S04); releasing the RRC connection after receiving the RRC connection release message by the UE (Step 4S05); making the UE enter the IDLE, CELL_PCH, or URA_PCH state (enter the IDLE state in the following example) after releasing the RRC connection by the UE (Step 4S06).

Wherein, the signaling connection release may be for PS domain to the communication network. The communication network may be a WCDMA network with mail service, even with real time mail service. The user inactive event may be defined by a software program which can be executed in the UE, and user inactive event may include an event of screen off, an event of data guard time expiration or both of these two events. Data guard time means the protection time interval between two data symbols. In the present invention, if the UE waits for the data guard time and has no data to transmit, the LE will send a signaling connection release message. Last, as stated above, the UE will enter the IDLE, CELL_PCH, or URA_PCH state. The above explanation is to explain the possible application and implementation of the method provided by the embodiment, and it is not intended to limit the scope of the invention.

Still referring to FIG. 4, the Step 4S00 and 4S01 is the key principle of the invention, adding an algorithm to force the communication network to release the RRC connection. Thus, it will be apparent to those skilled in the art that various modifications

and variations can be made to the steps of the method without departing from the scope or spirit of the invention.

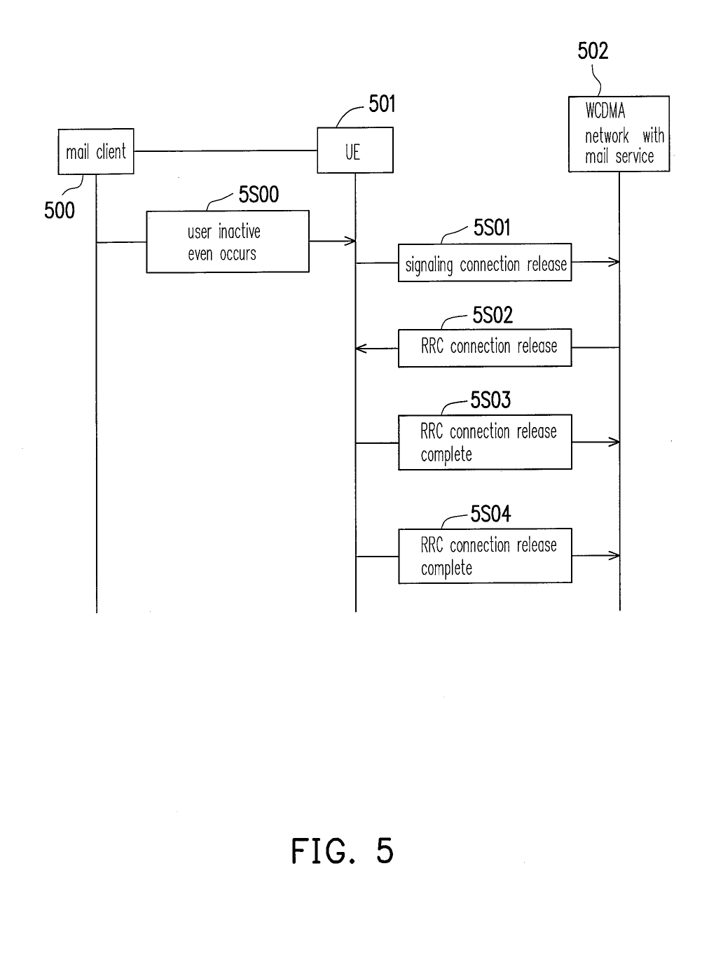

Referring to FIG. 5, FIG. 5 is the flow diagram showing the RRC connection release using the method provided by the invention. In FIG. 5, the mail client 500 may be an application software program which can be executed in the UE 501, the communication network is a WCDMA network with mail service, and it is not intended to limit the scope of the invention.

Still referring to FIG. 5, when the mail client 500 completes the synchronization process, the UE 501 checks if a user inactive event occurs (ex: screen off or data guard time expiration) (Step 5S00), the UE 501 sends the signaling connection release message on a dedicated control channel (Step 5S01). Then the WCDMA network with mail service 502 receives the signaling connection release message on the dedicated control channel, and then sends the RRC connection release message on the dedicated control channel (Step 5S02). The UE 501 receives the RRC connection release message on the dedicated control channel, releases the RRC connection after receiving the RRC connection release message, and responds a RRC connection release complete message to the WCDMA network 502 (Step 5S03). Generally speaking, the UE 501 may repeat to respond the RRC connection release complete message to the WCDMA network 502 to ensure that the RRC connection release is completed (Step 5S04).

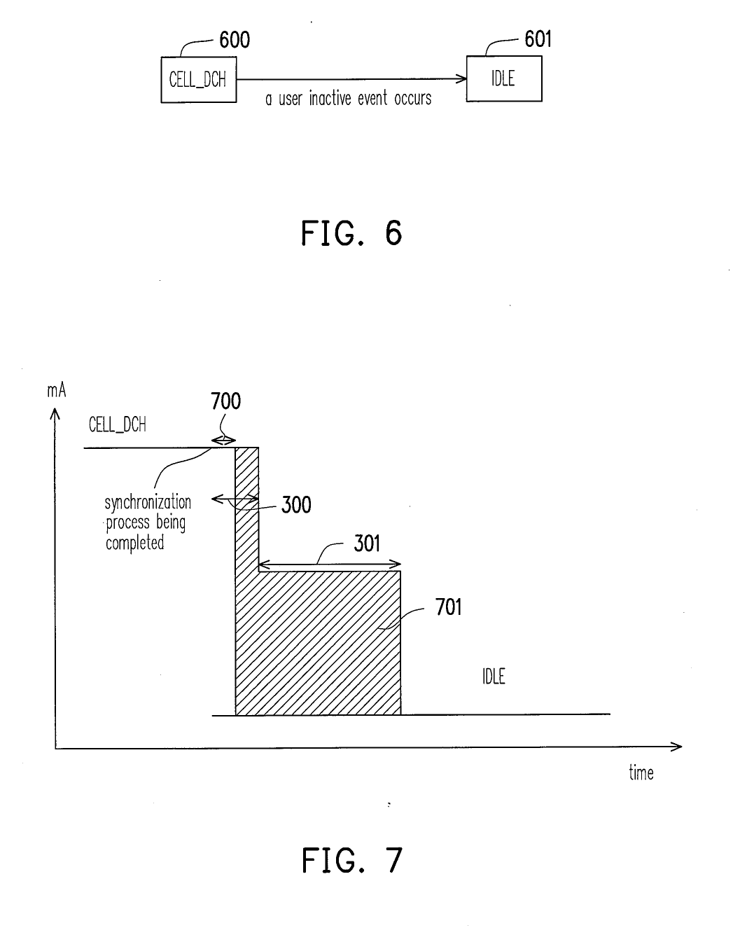

Referring to FIG. 6, FIG. 6 is a state diagram showing the transition of the UE under the CDMA network using the method provided by the invention. In FIG. 6, after UE completes the synchronization process, and the UE finds a user inactive event occurs, the LE will go to the IDLE state 601 from the CELL_DCH state 600.

Referring to FIG. 7, FIG. 7 is a scheme diagram showing power consumption on RRC transition of FIG. 6. It can be seen that after the synchronization process being completed, the UE finds a user inactive event occurs, for example: a data guard time 700 is expired, the UE sends the signaling connection release message to ask the WCDMA network to send the RRC connection release message or a physical channel reconfiguration to command the UE to go to the IDLE state from the CELL_DCH state. For using the method provided by the invention, the UE will save significant power during the DCH timeout interval 300 and the FACH timeout interval 301 waiting for the WCDMA network to release the RRC connection. Wherein, the block 701 presents the saved power during the DCH timeout interval 300 and the FACH timeout interval 301.

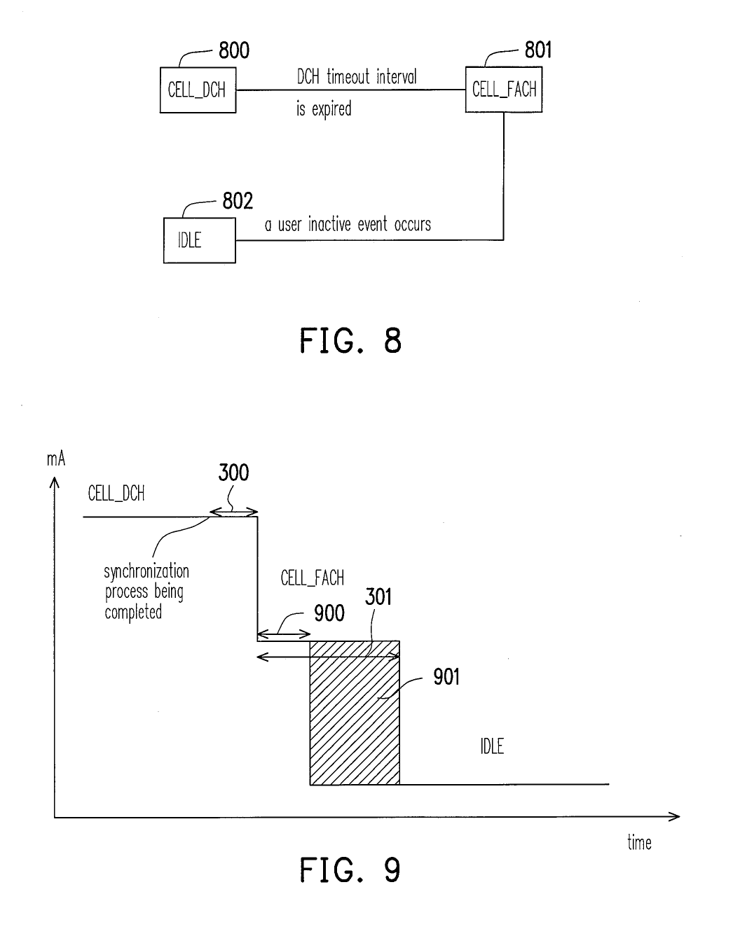

Referring to FIG. 8, FIG. 8 is a state diagram showing the transition of the UE under the WCDMA network using the method provided by the invention. In FIG. 8, after UE completes the synchronization process and the DCH timeout interval is expired, the UE goes to the CELL_FACH state 801 from the CELL_DCH state 800. Then the UE finds a user inactive event occurs, the UE will go to the IDLE state 802 from the CELL_FACH state 801.

Referring to FIG. 9, FIG. 9 is a scheme diagram showing power consumption on RRC transition of FIG. 8. It can be seen that after the synchronization process being completed and the DCH timeout interval 300 is expired, the UE goes to the CELL_FACH state from the CELL_DCH state. Then the UE finds a user inactive event occurs, for example: a data guard time 900 is expired, and the UE sends the signaling connection release message to ask the WCDMA network to send the RRC connection release message or a physical channel reconfiguration to command the LE to go to the IDLE state from the CELL_FACH state. For using the method provided by the invention, the UE will save significant power during the FACH timeout interval 301 waiting for the WCDMA network to release the RRC connection. Wherein, the block 901 presents the saved power during the FACH timeout interval 301.

Assuming the current and hours production of the battery in the UE is 1300 mah (milli-ampere*hour),the DCH timeout interval is 10 seconds, the FACH timeout interval is 10 seconds, the mail receiving rate is one mail per 10 minutes, the data guard time is 3 seconds, the wasted current of the IDLE state is 6 ma (milli-ampere), the mail receiving wastes 140 ma for 1 second and 365 ma for 9 seconds, the wasted current of the CELL_DCH without data transferring or receiving is 315 ma for 10 seconds, and the wasted current of the CELL_FACH without data transferring or receiving is 140 ma for 10 seconds. Still referring to FIG. 7, in FIG. 7, the wasted current of the battery in the UE using the method provided by the invention is (140+365*9+315*3+6*(600−13))/600=13.20 ma, and the estimated lifetime of the battery in the UE is 1300/13.20=98.48 hours. While under the conventional WCDMA network with mail service, the wasted current of the battery in the UE is (140+365*9+315*10+140*10+6*(600−30))/600=18.89 ma, and the estimated lifetime of the battery in the UE is 1300/18.89=68.45 hours.

As above, the methods provided by the invention can save the wasted UE power of the communication network on RRC transition and prolong the lifetime of the battery in the UE. And the method may be applied to the 3G and 3.5G network with little with adding an algorithm to force the communication network to release the RRC connection.

It will be apparent to those skilled in the art that various modifications and variations can be made to the method of the present invention without departing from the scope or spirit of the invention. In view of the foregoing descriptions, it is intended that the present invention covers modifications and variations of this invention if they fall within the scope of the following claims and their equivalents.

What is claimed is:

1. A method for reducing user equipment (UE) power consumption under a communication network, comprising:
checking if a user inactive event occurs in a UE; and
sending a signaling connection release message from the UE if the user inactive event occurs.

2. The method according to the claim 1, wherein, the UE power consumption being in a CELL_DCH state, in a CELL_FACH state, or in the CELL_DCH and CELL_FACH state.

3. The method according to the claim 1, wherein, the signaling connection release message being for Packet Switching (PS) domain to the communication network.

4. The method according to the claim 1, further comprising:
receiving a RRC connection release message by the UE;
releasing a RRC connection of the UE after receiving the RRC connection release message by the UE; and
making the UE enter an IDLE state, a CELL_PCH or an URA_PCH after releasing the RRC connection by the UE.

5. The method according to the claim 4, further comprising:
receiving the signaling connection release message by the communication network; and
sending a RRC connection release message from the communication network.

6. The method according to the claim 1, wherein, the user inactive event in the UE including an event of screen off, an event of data guard time expiration or both of these two events.

7. The method according to the claim 1, wherein, the communication network being a WCDMA network with mail service.

8. The method according to the claim 7, wherein, the WCDMA network with mail service being a WCDMA network with real-time mail service.

9. The method according to the claim 1, wherein, the user inactive event in the UE being defined by a software program which can be executed in the UE.

10. A method for reducing UE power consumption in a CELL_FACH or CELL_DCH state under a WCDMA network with mail service, comprising:
checking if a user inactive event occurs in a UE; and
sending a signaling connection release message from the UE if the user inactive event occurs;
wherein, the signaling connection release message being for Packet Switching (PS) domain to the communication network, and the user inactive event in the UE being defined by a software program which can be executed in the UE.

11. The method according to the claim 10, further comprising:
receiving a RRC connection release message by the UE;
releasing a RRC connection of the UE after receiving the RRC connection release message by the UE; and
making the UE enter an IDLE state, a CELL_PCH or an URA_PCH after releasing the RRC connection by the UE.

12. The method according to the claim 11, further comprising:
receiving the signaling connection release message by the WCDMA network; and
sending a RRC connection release message on the dedicated control channel from the WCDMA network.

13. The method according to the claim 10, wherein, the user inactive event including an event of screen off, an event of data guard time expiration or both of these two events.

14. The method according to the claim 10, wherein, the WCDMA network with mail service being a WCDMA network with real-time mail service.
